(19) United States
(12) Patent Application Publication
(10) Pub. No.: US 2015/0168793 A1
(43) Pub. Date: Jun. 18, 2015

(54) CURVED DISPLAY APPARATUS

(71) Applicant: Samsung Display Co., Ltd., Yongin-City (KR)

(72) Inventors: SEJOON OH, Suwon-si (KR); Wan-Soon IM, Cheonan-si (KR)

(21) Appl. No.: 14/312,796

(22) Filed: Jun. 24, 2014

(30) Foreign Application Priority Data
Dec. 17, 2013 (KR) 10-2013-0157330

(51) Int. Cl. G02F 1/1362; G02F 1/1343; G02F 1/1333; G02F 1/1368

(52) U.S. Cl. CPC G02F 1/136286; G02F 1/136209; G02F 1/1368; G02F 1/134336; G02F 1/133345; G02F 2001/136218; G02F 2001/134345

(57) ABSTRACT

A curved display apparatus curved in a first direction includes a first substrate which includes a first base substrate and a plurality of pixel electrodes disposed on the first base substrate, a second substrate which includes a second base substrate, a protrusion pattern disposed between two adjacent pixel electrodes among the plurality of pixel electrodes in a plan view and protruded from the second base substrate, and a common electrode disposed on the second base substrate which is configured to generate an electric field in cooperation with the plurality of pixel electrodes, and a liquid crystal layer interposed between the first substrate and the second substrate.

This U.S. non-provisional patent application claims priority to Korean Patent Application No. 10-2013-0157330, filed on Dec. 17, 2013, and all the benefits accruing therefrom under 35 U.S.C. §119, the contents of which are hereby incorporated by reference in its entirety.

### BACKGROUND

1. Field

The invention relates to a display apparatus. More particularly, the invention relates to a curved display apparatus including a curved display panel.

2. Description of the Related Art

A liquid crystal display (“LCD”) includes two transparent substrates and a liquid crystal layer disposed between the two substrates. The LCD drives the liquid crystal layer to control a light transmittance in each pixel, thereby displaying a desired image.

In a vertical alignment (“VA”) mode LCD among various operation modes of the LCD, liquid crystal molecules of the liquid crystal layer are vertically aligned when an electric field is generated between the two substrates to transmit the light, to thereby the image. The VA mode LCD aligns the liquid crystal molecules in different directions by using liquid crystal domains, and thus a viewing angle of the LCD is improved.

In recent years, a curved display apparatus has been developed. The curved display apparatus has a curved display area in which the image is displayed, and thus the curved display apparatus provides a viewer with the image having improved three-dimensional (“3D”) effect, sense of immersion, virtual presence, etc.

### SUMMARY

The invention provides a curved display apparatus capable of improving a display quality of a curved display panel thereof.

Exemplary embodiments of the invention provide a curved display apparatus curved in a first direction and including a first substrate, a second substrate facing the first substrate, and a liquid crystal layer interposed between the first and second substrates. The first substrate includes a first base substrate and a plurality of pixel electrodes disposed on the first base substrate. The second substrate includes a second base substrate, a protrusion pattern disposed between two adjacent pixel electrodes of the plurality of pixel electrodes to each other among the pixel electrodes in a plan view and protruded from the second base substrate, and a common electrode disposed on the second base substrate which is configured to generate an electric field in cooperation with the plurality of pixel electrodes.

In an exemplary embodiment, the first substrate further may include a plurality of signal lines disposed on the first base substrate and an insulating layer covering the signal lines. The protrusion pattern is disposed along signal lines extending in a second direction crossing the first direction among the signal lines in the plan view.

In an exemplary embodiment, the first substrate may further include a shielding electrode disposed along the signal lines extending in the second direction among the signal lines and electrically insulated from the pixel electrodes. The protrusion pattern may have a width equal to or greater than a width of the shielding electrode in a cross section.

In an exemplary embodiment, the signal lines may include gate lines extending in the first direction and data lines extending in the second direction, and the shielding electrode may be disposed along the data lines.

According to the above, although the misalignment occurs between the first and second substrates, the curved display apparatus may have improved response speed.

### BRIEF DESCRIPTION OF THE DRAWINGS

The above and other advantages of the invention will become readily apparent by reference to the following detailed description when considered in conjunction with the accompanying drawings, in which:

FIG. 1A is a perspective view showing a curved display apparatus according to an exemplary embodiment of the invention;

FIG. 1B is a cross-sectional side view showing the curved display apparatus shown in FIG. 1A;

FIG. 2 is a plan view showing an exemplary embodiment of a first substrate according to the invention;

FIG. 3A is a cross-sectional view taken along line I-I′ shown in FIG. 2;

FIG. 3B is a cross-sectional view taken along line II-II′ shown in FIG. 2;

FIG. 4 is a graph showing a response time of a liquid crystal layer as a function of a height of a protrusion pattern on a second base substrate;

FIG. 5 is a plan view showing an exemplary embodiment of a pixel structure of a curved display apparatus according to the invention;

FIG. 6A is a cross-sectional view taken along line III-III′ shown in FIG. 5;

FIG. 6B is a cross-sectional view taken along line IV-IV′ shown in FIG. 5;

FIG. 7A is a graph showing an exemplary embodiment of a brightness in a boundary area between two adjacent pixels of a curved display apparatus when the pixels are driven to white according to the invention; and

FIGS. 7A and 7B are graphs showing exemplary embodiments of a brightness measured in nits in a boundary area between two adjacent pixels of a curved display apparatus when the pixels are driven to display a white color and a black color, respectively, according to the invention.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be explained in detail with reference to the accompanying drawings.

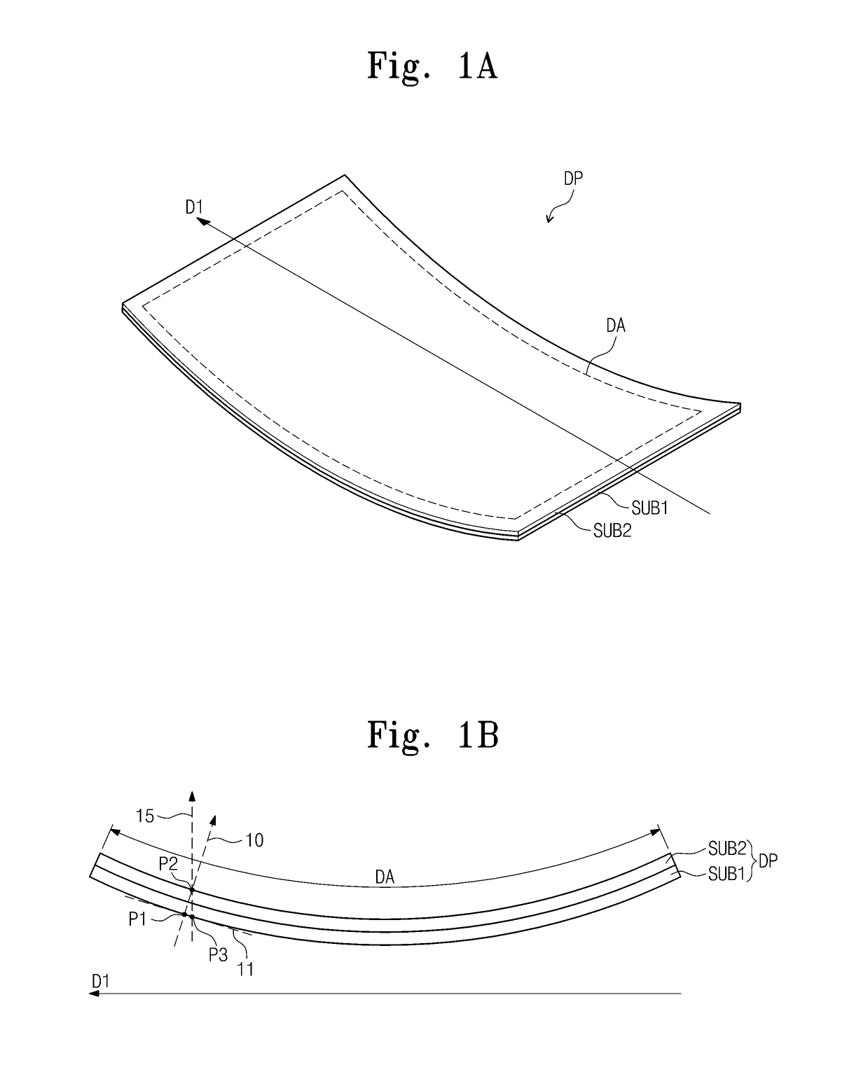

FIG. 1A is a perspective view showing a curved display apparatus according to an exemplary embodiment of the invention and FIG. 1B is a cross-sectional side view showing the curved display apparatus shown in FIG. 1A.

Referring to FIG. 1A, a display apparatus DP has a shape curved in a first direction D1. In particular, the display apparatus DP is curved in a direction in which a viewer sees the display apparatus DP such that the viewer recognizes an image displayed in a curved display screen, i.e., a display area DA. Hereinafter, the display apparatus DP which provides the display area DA having the curved shape is referred to as the curved display apparatus. When the image is displayed through the curved display apparatus DP, three-dimensional (“3D”) effect, sense of immersion, and virtual presence of the image recognized by the viewer may be improved.

The curved display apparatus DP includes a first substrate SUB1, a second substrate SUB2 which is disposed on and faces the first substrate SUB1, and a light control layer (not shown) interposed between the first substrate SUB1 and the second substrate SUB2. In the illustrated exemplary embodiment, a liquid crystal layer will be described as a light control layer.

The first and second substrates SUB1 and SUB2 have a shape curved in the first direction D1. A portion or a whole portion of the first substrate SUB1 may be continuously curved in the first direction D1, and thus the display area DA is curved in the first direction D1 to have the curved shape. In addition, the second substrate SUB2 may be curved along the first substrate SUB1.

In the illustrated exemplary embodiment, a center portion of the curved display apparatus DP may be lower than both end portions thereof in a cross section.

Referring to FIG. 1B, when the first and second substrates SUB1 and SUB2 are curved, a normal line 10 vertical to a tangent line 11 that contacts a first point P1 of the first substrate SUB1 passes through a second point P2 of the second substrate SUB2. However, a gaze line 15, which passes through the second point P2 in a direction at which the viewer sees the curved display apparatus DP, passes through a third point P3 different from the first point P1 in the first substrate SUB1.

In exemplary embodiments, a distance between the first point P1 and the third point P3 may have a value depending on a curvature of the curved display apparatus DP. That is, as the curvature of the curved display apparatus DP is increased, the distance between the first point P1 and the third point P3 is increased.

As described above, a phenomenon in which a position of the first point P1 does not match with that of the third point P3 is referred to as a mis-alignment between the first substrate SUB1 and the second substrate SUB2. Hereinafter, a structure of the curved display apparatus DP, which effectively prevents a texture defect from being recognized due to the mis-alignment, will be described.

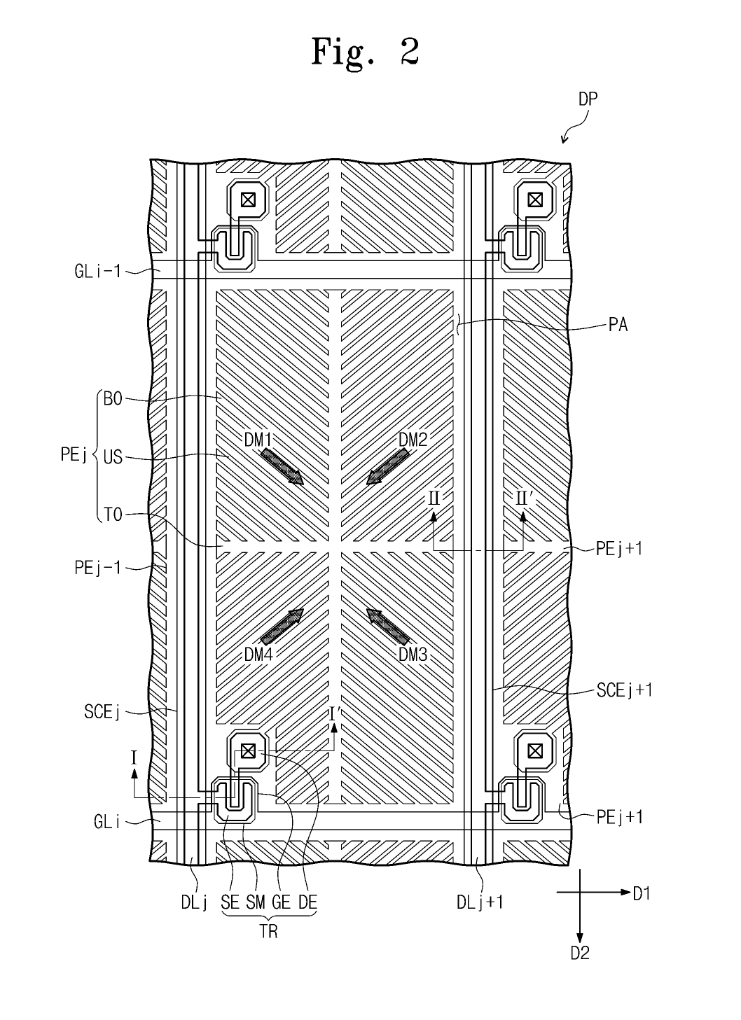

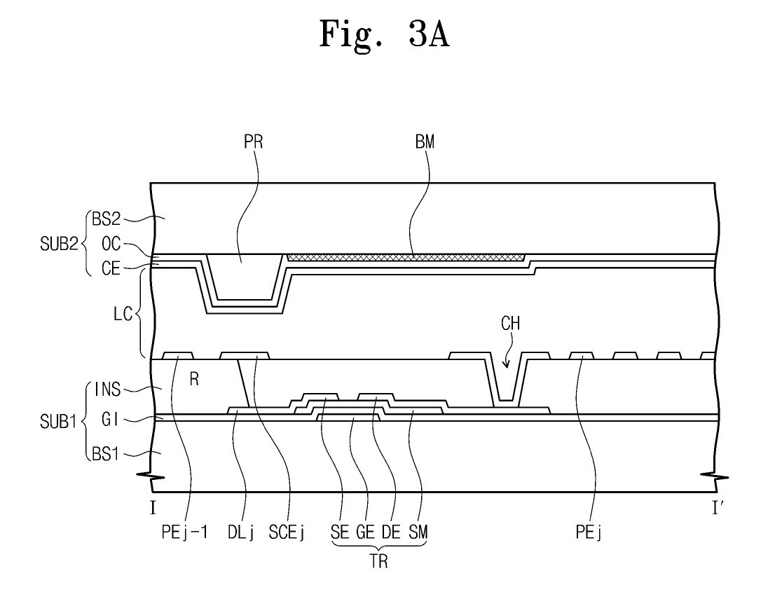

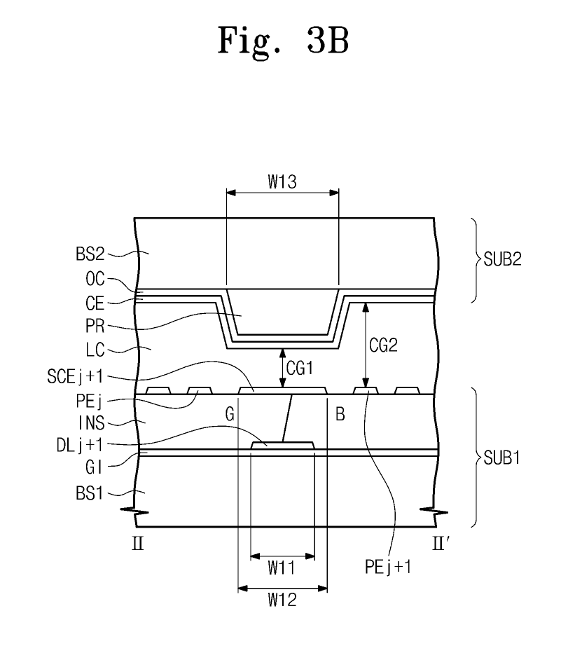

FIG. 2 is a plan view showing the first substrate SUB1 according to an exemplary embodiment of the invention, FIG. 3A is a cross-sectional view taken along line I-I′ shown in FIG. 2, and FIG. 3B is a cross-sectional view taken along line II-II′ shown in FIG. 2.

Referring to FIGS. 2, 3A, and 3B, the curved display apparatus DP includes the first substrate SUB1, the second substrate SUB2, and the liquid crystal layer LC interposed between the first substrate SUB1 and the second substrate SUB2.

The curved display apparatus DP includes a plurality of pixel areas PA arranged in a matrix form. For the convenience of explanation, only one pixel area PA arranged in an i-th row by a j-th column has been shown in FIGS. 2, 3A, and 3B. Hereinafter, “i” and “j” indicate the number of row and column of the pixel. Since the pixel areas PA have the same structure, for the convenience of explanation, only one pixel will be described in the illustrated exemplary embodiment. In an exemplary embodiment, the pixel area PA has a rectangular shape elongated in one direction, but it should not be limited thereto or thereby. That is, in other exemplary embodiments, the pixel area PA may have various other shapes, e.g., a V shape, a Z shape, etc.

The first substrate SUB1 includes a first base substrate BS1, a gate line GL, a data line DL, a thin film transistor (“TFT”) TR, a pixel electrode PE, and a shielding electrode SCE.

The first base substrate BS1 includes an insulating material and has flexibility.

The gate line GL is provided in a plural number and extends in the first direction D1 on the first base substrate BS1. FIGS. 2, 3A, and 3B show (i−1)th and i-th gate lines GLi−1 and GLi among the gate lines GL, and hereinafter, the (i−1)th and i-th gate lines GLi−1 and GLi will be referred to as first and second gate liens GLi−1 and GLi, respectively.

The data line DL is provided in a plural number and extends in a second direction D2 crossing the first direction D1. The data lines DL are disposed on the first base substrate BS1 and insulate from the gate lines GL with a gate insulating line GI disposed between the data lines DL and the gate lines GL. FIGS. 2, 3A, and 3B show j-th and (j+1)th data lines DLj and DLj+1 among the data lines DL, and hereinafter, the j-th and (j+1)th data lines DLj and DLj+1 will be referred to as first and second data lines DLj and DLj+1, respectively.

The TFT TR is electrically connected to the second gate line GLi and the first data line DLj to switch a signal applied to the pixel electrode PEj, which will be described below in further detail. In detail, the TFT TR includes a gate electrode GE branched from the second gate line GLi, a source electrode SE branched from the first data line DLj, and a drain electrode DE electrically connected to the pixel electrode PEj. A semiconductor pattern SM is disposed between the source electrode SE and the drain electrode DE to provide a conductive channel.

An insulating layer INS is disposed on the TFT TR. The insulating layer INS is disposed to correspond to the pixel areas PA. The insulating layer INS includes a color pixel representing a color. In an exemplary embodiment, the color pixel may be a red color pixel R, a green color pixel G, or a blue color pixel B, and may further include a magenta color pixel, a yellow color pixel, a cyan color pixel, etc.

The pixel electrode PEj is connected to the second gate line GLi and the first data line DLj through the TFT TR. The pixel electrode PEj is disposed in the pixel area PA. The pixel electrode PEj is disposed on the insulating layer and connected to the drain electrode DE of the TFT TR through a contact hole CH.

The pixel electrode PEj is spaced apart from and electrically insulated from other pixel electrodes, i.e., a left side pixel electrode PEj−1 and a right side pixel electrode PEj+1, adjacent to the pixel electrode PEj.

In the illustrated exemplary embodiment, the pixel electrode PEj includes a trunk portion T0 and a plurality of branch portions B0 extending from the trunk portion T0 in a radial form, for example. The trunk portion T0 has a cross shape, and thus the pixel area PA is divided into four domains, i.e., first, second, third, and fourth domains DM1, DM2, DM3, and DM4, by the trunk portion T0. The branch portions B0 extend substantially in parallel to each other and are spaced apart from each other in each domain defined by the trunk portion T0. As an exemplary embodiment, the branch portions B0 extend in a direction inclined at about 45 degrees with respect to the trunk portion T0. In the branch portions B0, a distance between two adjacent branch portions B0 to each other is measured in terms of a micrometer, and a plurality of micro-slits US is defined therebetween. Due to the micro-slits US, liquid crystal molecules of the liquid crystal layer LC are aligned in different directions in each domain when the liquid crystal molecules are initially aligned.

According to another exemplary embodiment, the shape of the pixel electrode PEj should not be limited to the above-described shape.

A first shielding electrode SCEj is disposed between the pixel electrode PEj and the left side pixel electrode PEj−1 and a second shielding electrode SCEj+1 is disposed between the pixel electrode PEj and the right side pixel electrode PEj+1.

The first and second shielding electrodes SCEj and SCEj+1 are disposed along the first and second data lines DLj and DLj+1, respectively, and have a width W12 equal to or greater than a width W11 of the first and second data lines DLj and DLj+1. When viewed in a plan view, the first and second shielding electrodes SCEj and SCEj+1 are disposed to cover the first and second data lines DLj and DLj+1, respectively.

The first shielding electrode SCEj is electrically insulated from the pixel electrode PEj and the left side pixel electrode PEj+1 and the second shielding electrode SCEj+1 is electrically insulated from the pixel electrode PEj and the right side pixel electrode PEj+1.

In an exemplary embodiment, the first and second shielding electrodes SCEj and SCEj+1 are applied with a voltage at the same level as that of the common voltage applied to the common electrode. Accordingly, the electric field is not generated between the first shielding electrode SCEj and the common electrode CE and between the second shielding electrode SCEj+1 and the common electrode CE. In an exemplary embodiment, when the liquid crystal molecules of the liquid crystal layer LC have a negative dielectric anisotropy, the liquid crystal molecules are vertically aligned with respect to the surface of the second shielding electrode SCEj+1 in a non-electric field state. When the liquid crystal molecules are vertically aligned, the light provided from the backlight assembly is blocked by the liquid crystal molecules vertically aligned. Therefore, when an area to block the light provided form the backlight assembly is defined as a light blocking area, the areas in which the first and second shielding electrodes SCEj and SCEj+1 are provided may serve as the light blocking areas. As described above, since the first and second shielding electrodes SCEj and SCEj+1 are provided along the first and second data lines DLj and DLj+1, respectively, the light emitting areas are provided in the second direction D2. As a result, a black matrix BM is not disposed on the second substrate SUB2 corresponding to the areas in which the first and second shielding electrodes SCEj and SCEj+1 are provided.

When the pixel electrode PEj and the first and second shielding electrodes SCEj and SCEj+1 are disposed on the first substrate SUB1, the light blocking area may be effectively prevented from moving to the pixel area PA even though the first substrate SUB1 and the second substrate SUB2 are misaligned with each other. Thus, a vertical dark line may be effectively prevented from appearing on the pixel area PA along the second direction D2 substantially vertical to the first direction D1 in which the curved display apparatus DP is curved.

In another exemplary embodiment, the first and second shielding electrodes SCEj and SCEj+1 may be omitted. When the first and second shielding electrodes SCEj and SCEj+1 are omitted, a separate light blocking member, e.g., the black matrix BM, may be disposed in areas corresponding to the areas in which the first and second shielding electrodes SCEj and SCEj+1 are provided. In an exemplary embodiment, the black matrix BM may be disposed on one of the first substrate SUB1 and the second substrate SUB2.

The second substrate SUB2 is disposed to face the first substrate SUB1. The second substrate SUB2 includes a second base substrate BS2, a protrusion pattern PR, a black matrix BM, an overcoating layer OC, and the common electrode CE.

The second base substrate BS2 includes an insulating material and has flexibility.

The protrusion pattern PR is disposed on the second base substrate BS2 and extends in the second direction D2. The protrusion pattern PR is provided along the first and second data lines DLj and DLj+1 and has a width W13 equal to or greater than the width W11 of each of the first and second data lines DLj and DLj+1. When viewed in a plan view, the protrusion pattern PR is disposed to cover the first and second data lines DLj and DLj+1. In addition, the protrusion pattern PR is provided along the first and second shielding electrodes SCEj and SCEj+1 and has the width W13 equal to or greater than the width W12 of each of the first and second shielding electrodes SCEj and SCEj+1. When viewed in a plan view, the protrusion pattern PR covers the first and second shielding electrodes SCEj and SCEj+1.

When a distance between the first substrate SUB1 and the second substrate SUB2 is referred to as a cell gap, the cell gap in an area in which the protrusion pattern PR is provided is smaller than that in an area in which the protrusion pattern PR is not provided since the protrusion pattern PR is protruded from the second base substrate BS2. In detail, a distance CG1 between the common electrode CE disposed on the protrusion pattern PR and the first and second shielding electrodes SCEj and SCEj+1 disposed on the first substrate SUB1 is smaller than a distance CG2 between the common electrode CE disposed in the area in which the protrusion pattern PR is not disposed and the first and second shielding electrodes SCEj and SCEj+1. As a height of the protrusion pattern PR from the second substrate SUB2 becomes greater, the cell gap becomes smaller.

The height of the protrusion pattern PR may be set depending on a wavelength of light passing through the liquid crystal layer LC and a refractive index anisotropy of the liquid crystal layer LC. In an exemplary embodiment, the height of the protrusion pattern PR may be λ*m/(2*Δn), where “m” is a positive odd number, “λ” is a wavelength of light passing through the liquid crystal layer LC, and “Δn” is the refractive index anisotropy of the liquid crystal layer LC, for example.

In an exemplary embodiment, the protrusion pattern PR may include an organic polymer, such as polyimide, polyamideimide, polyamide, polyetherimide, polyetheretherketone, polyetherketone, polyketonesulfide, polyethersulfone, cycloolefin polymer, polysulfone, polyphenylenesulfide, polyphenyleneoxide, polyethyleneterephthalate, polybutyleneterephthalate, polyethylenenaphthalate, polyacetal, polycarbonate, polyacrylate, acryl resin, acrylic resin, polyvinylalcohol, polypropylene, cellulose, triacetylcellulose, epoxy resin, phenol resin, or any combinations thereof, for example.

The black matrix BM is disposed on the second base substrate BS2 to block the light passing through the liquid crystal layer LC. The black matrix BM is disposed to cover the gate line GL. In addition, the black matrix BM is disposed to cover the TFT TR when viewed in a plan view.

The overcoating layer OC is disposed on the protrusion pattern PR and the black matrix BM to cover the protrusion pattern PR and the black matrix BM. In another exemplary embodiment, the overcoating layer OC may be omitted.

The common electrode CE is disposed on the overcoating layer OC and generates the electric field in cooperation with the pixel electrode PE.

The liquid crystal layer LC includes the liquid crystal molecules having the dielectric anisotropy and the refractive index anisotropy. In the illustrated exemplary embodiment, the liquid crystal layer LC may include the liquid crystal molecules having a negative dielectric anisotropy.

In the liquid crystal layer LC, the liquid crystal molecules may be aligned in different directions from each other when the liquid crystal molecules are initially aligned. FIG. 2 shows the liquid crystal molecules initially aligned in different directions in the first, second, third, and fourth domains DM1, DM2, DM3, and DM4.

The liquid crystal molecules of the liquid crystal layer LC are aligned by the electric field provided between the pixel electrode PE and the common electrode CE. The common electrode CE is applied with the common voltage and the pixel electrode PE is applied with the data voltage from the first data line DLj. Accordingly, the electric field is generated to correspond to a difference in electric potential between the common voltage and the data voltage, and the alignment of the liquid crystal molecules of the liquid crystal layer LC is changed in accordance with intensity of the electric field, thereby controlling the transmittance of the light passing through the liquid crystal layer LC.

In an exemplary embodiment, the light supplied to the liquid crystal layer LC may be the light provided from the backlight assembly (not shown) disposed at a rear side of the first substrate SUB1, for example.

The curved display apparatus having the above-described structure has a response speed that is not substantially slow even when the misalignment occurs between the first substrate SUB1 and the second substrate SUB2 due to the following reason.

As discussed above, the liquid crystal molecules of the liquid crystal layer LC are initially aligned in different directions in each of the first, second, third, and fourth domains DM1, DM2, DM3, and DM4. However, when the misalignment occurs between the first substrate SUB1 and the second substrate SUB2, the initial alignment of the liquid crystal molecules in the boundary area between the two adjacent pixels to each other, i.e., in the areas in which the data line DL and/or the shielding electrode SCE are provided, is changed. Due to the change of the initial alignment of the liquid crystal molecules, the response speed of the liquid crystal molecules is lowered.

In the illustrated exemplary embodiment, the protrusion pattern PR is provided in the boundary area between the two adjacent pixels to each other, i.e., in the areas in which the data line DL and/or the shielding electrode SCE are provided. The cell gap in the area in which the protrusion pattern PR is disposed is smaller than the cell gap in the area in which the protrusion pattern PR is not disposed, and thus the response speed of the liquid crystal molecules in the area in which the protrusion pattern PR is disposed is faster than the response speed of the liquid crystal molecules in the area in which the protrusion pattern PR is not disposed.

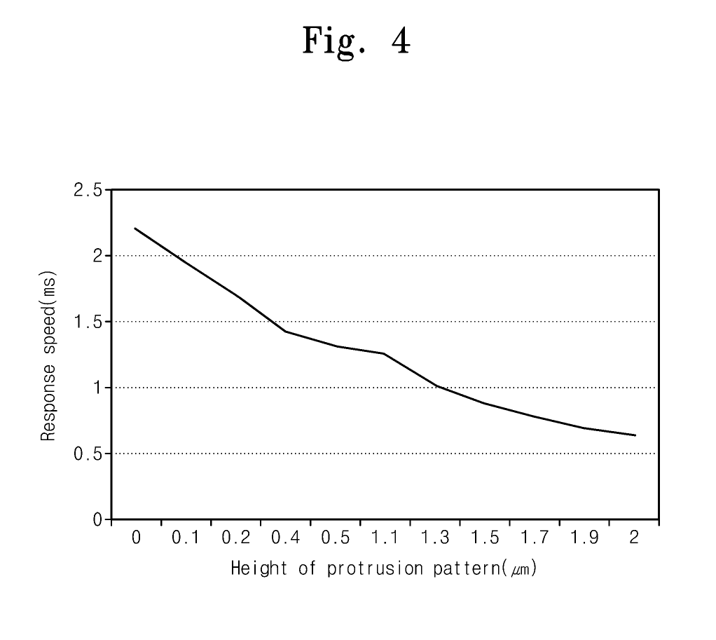

FIG. 4 is a graph showing the response time of the liquid crystal layer as a function of the height of the protrusion pattern on the second base substrate.

Referring to FIG. 4, as the height of the protrusion pattern measured in micrometers (μm) becomes high, the response speed measured in milliseconds (ms) becomes slow. This means that the response speed becomes fast as the cell gap becomes small. In addition, the response speed according to the height of the protrusion pattern is predictable. Therefore, when the height of the protrusion pattern is controlled, the response speed in the boundary area between the adjacent two pixels to each other may be controlled. As a result, although the initial alignment direction in the boundary area between the two pixels adjacent to each other is changed by the misalignment occurring between the first substrate and the second substrate, the response speed may be controlled by providing the protrusion pattern.

The curved display apparatus according to the illustrated exemplary embodiment may have different structure from the above-described structure.

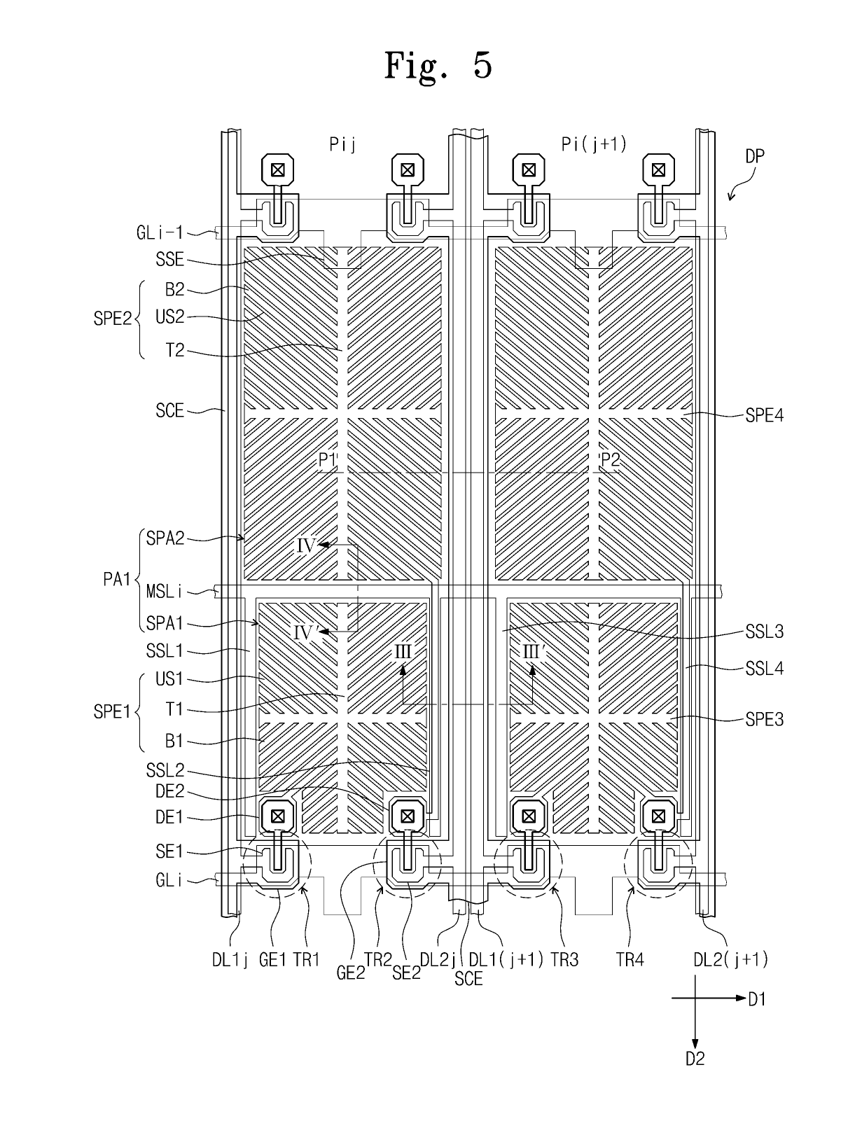

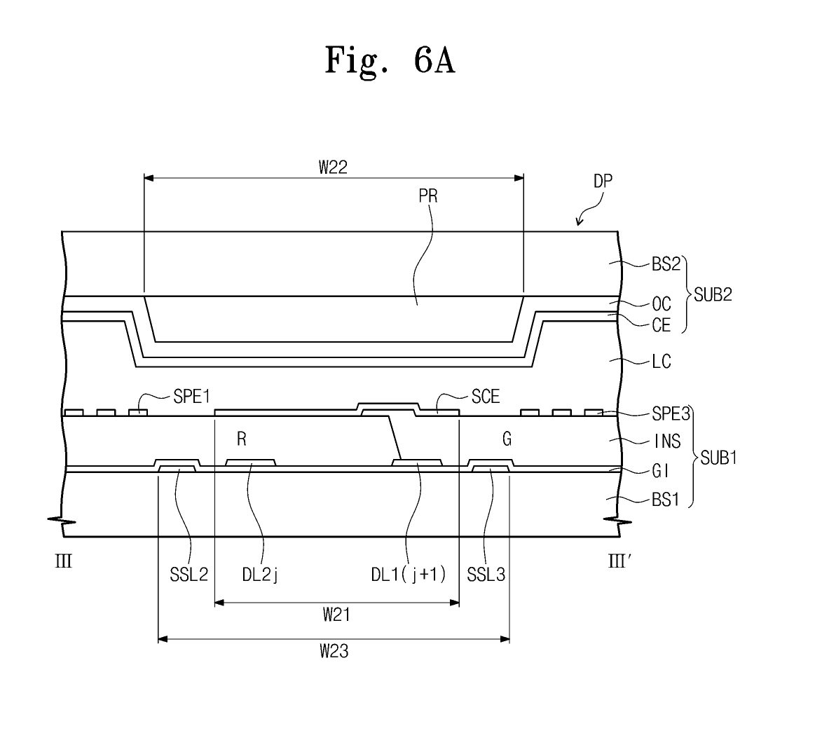

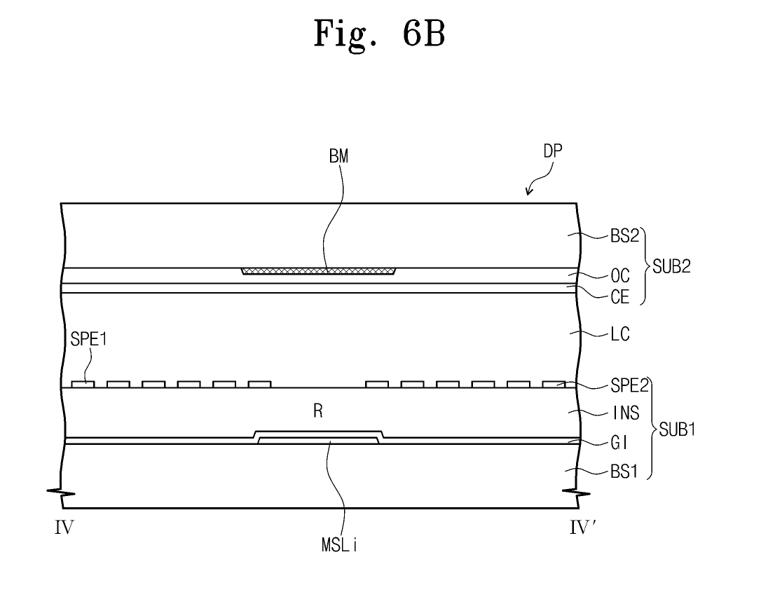

FIG. 5 is a plan view showing a pixel structure of a curved display apparatus according to an exemplary embodiment of the invention, FIG. 6A is a cross-sectional view taken along a line III-III′ shown in FIG. 5, and FIG. 6B is a cross-sectional view taken along a line IV-IV′ shown in FIG. 5. The curved display apparatus DP includes a plurality of pixels. For the convenience of explanation, however, only two pixels, e.g., a first pixel Pij and a second pixel Pi(j+1), arranged in the first direction D1 have been shown in FIG. 5. Details of other pixels will be omitted since the other pixels have the same structure and function as those of the two pixels.

Referring to FIGS. 5, 6A, and 6B, the curved display apparatus DP includes a first substrate SUB1, a second substrate SUB2 facing the first substrate SUB1, and a liquid crystal layer LC interposed between the first substrate SUB1 and the second substrate SUB2.

The first substrate SUB1 includes a first base substrate BS1, first and second gate lines GLi−1 and GLi, first, second, third, and fourth data lines DL1j, DL2j, DL1(j+1), and DL2(j+1), and a storage line.

In an exemplary embodiment, the first base substrate BS1 may be an insulating substrate having light transmitting property and flexibility, e.g., a plastic substrate. In an exemplary embodiment, the first pixel Pij is disposed in a first pixel area defined by the first and second gate lines GLi−1 and GLi and the first and second data lines DL1j and DL2j, and the second pixel Pi(j+1) is disposed in a second pixel area defined by the first and second gate lines GLi−1 and GLi and the third and fourth data lines DL1(j+1) and DL2(j+1). However, the invention is not limited thereto, and the plurality of pixels may not be defined by the gate lines and the data lines.

The first pixel Pij includes first and second thin film transistors TR1 and TR2 and first and second sub-pixel electrodes SPE1 and SPE2, and the second pixel Pi(j+1) includes third and fourth thin film transistors TR3 and TR4 and third and fourth sub-pixel electrodes SPE3 and SPE4.

A shielding electrode SCE is disposed between the first and second pixels Pij and Pi(j+1). The shielding electrode SCE extends in a second direction D2 substantially perpendicular to the first direction D1.

As shown in FIG. 5, the first and second gate lines GLi−1 and GLi extend in the first direction D1 and the first, second, third, and fourth data lines DL1j, DL2j, DL1(j+1), and DL2(j+1) extend in the second direction D2 substantially perpendicular to the first direction D1. The first and second gate lines GLi−1 and GLi are insulated from the first, second, third, and fourth data lines DL1j, DL2j, DL1(j+1), and DL2(j+1) while crossing the first, second, third, and fourth data lines DL1j, DL2j, DL1(j+1), and DL2(j+1) by the gate insulating layer GI.

The first TFT TR1 includes a first gate electrode GE1 branched from the second gate line GLi, a first source electrode SE1 branched from the first data line DL1j, and a first drain electrode DE1 spaced apart from the first source electrode SE1 by a predetermined distance. The second TFT TR2 includes a second gate electrode GE2 branched from the second gate line GLi, a second source electrode SE2 branched from the second data line DL2j, and a second drain electrode DE2 spaced apart from the second source electrode SE2 by a predetermined distance.

The first pixel area PA1 includes a first sub-pixel area SPA1 and a second sub-pixel area SPA2 arranged in the second direction D2. In an exemplary embodiment, the first sub-pixel area SPA1 may have a size different from a size of the second sub-pixel area SPA2. In detail, the first sub-pixel area SPA1 may be smaller than the second sub-pixel area SPA2.

The first sub-pixel electrode SPE1 is disposed in the first sub-pixel area SPA1 and electrically connected to the first drain electrode DE1 of the first TFT TR1. The second sub-pixel electrode SPE2 is disposed in the second sub-pixel area SPA2 and electrically connected to the second drain electrode DE2 of the second TFT TR2.

The first sub-pixel electrode SPE1 includes a first trunk portion T1 and a plurality of first branch portions B1 extending from the first trunk portion T1 in a radial form to divide the first sub-pixel area SPA1 into plural domains. In an exemplary embodiment, the first trunk portion T1 has a cross shape, and thus the first sub-pixel area SPA1 is divided into four domains by the first trunk portion T1. The first branch portions B1 extend substantially in parallel to each other and are spaced apart from each other in each domain defined by the first trunk portion T1. As an exemplary embodiment, the first branch portions B1 extend in a direction inclined at about 45 degrees with respect to the first trunk portion T1. In the first branch portions B1, a distance between two adjacent first branch portions B1 to each other is measured in terms of a micrometer, and a plurality of first micro-slits US1 is defined therebetween. Due to the first micro-slits US1, liquid crystal molecules of the liquid crystal layer LC are aligned in different directions in each domain when the liquid crystal molecules are initially aligned.

The second sub-pixel electrode SPE2 includes a second trunk portion T2 and a plurality of second branch portions B2 extending from the second trunk portion T2 in a radial form to divide the second sub-pixel area SPA2 into plural domains. The second trunk portion T2 has a cross shape, and thus the second sub-pixel area SPA2 is divided into four domains by the second trunk portion T2. The second branch portions B2 extend substantially in parallel to each other and are spaced apart from each other in each domain defined by the second trunk portion T2. In the second branch portions B2, a distance between two adjacent second branch portions B2 to each other is measured in terms of a micrometer, and a plurality of second micro-slits US2 is defined therebetween. Due to the second micro-slits US2, liquid crystal molecules of the liquid crystal layer LC are aligned in different directions in each domain when the liquid crystal molecules are initially aligned.

The storage line is disposed between the first sub-pixel area SPA1 and the second sub-pixel area SPA2 and includes a main storage line MSLi extending in the first direction D1, and first and second sub-storage lines SSL1 and SSL2 branched from the main storage line MSLi and extending in the second direction D2.

The main storage line MSLi is partially overlapped with the first and second sub-pixel electrodes SPE1 and SPE2 in a plan view. The first and second sub-storage lines SSL1 and SSL2 are partially overlapped with the first sub-pixel electrode SPE1. In an exemplary embodiment, a distance between the first and second sub-storage lines SSL1 and SSL2 is smaller than a distance between the first and second data lines DL1j and DL2j, and a width of the first sub-pixel electrode SPE1 along the first direction D1 in a plan view is greater than a distance between the first and second sub-storage lines SSL1 and SSL2 and smaller than a distance between the first and second data lines DL1j and DL2j.

In an exemplary embodiment, the first pixel Pij further includes a storage electrode SSE branched from the first gate line GLi−1 and partially overlapped with the second sub-pixel electrode SPE2.

The second pixel Pi(j+1) has the same structure and function as those of the first pixel Pij, and thus details thereof will be omitted.

The second pixel Pi(j+1) shares the first and second gate lines GLi−1 and GLi with the first pixel Pij. However, separately from the first pixel Pij, the second pixel Pi(j+1) includes third and fourth thin film transistors TR3 and TR4 electrically connected to the third and fourth data lines DL1(j+1) and DL2(j+1) and third and fourth sub-pixel electrodes SPE3 and SPE4 electrically connected to the third and fourth thin film transistors TR3 and TR4, respectively. In addition, the second pixel Pi(j+1) includes third and fourth sub-storage lines SSL3 and SSL4.

FIG. 6A shows the cross-sectional view in the boundary area between the first pixel Pij and the second pixel Pi(j+1).

As shown in FIG. 6A, the second and third sub-storage lines SSL2 and SSL3 are disposed on the first base substrate BS1 through the same process used to provide the first and second gate lines GLi−1 and GLi. That is, the sub-storage lines SSL may be in a same layer as the gate lines GL. The second and third sub-storage lines SSL2 and SSL3 are covered by the gate insulating layer GI and the second and third data lines DL2j and DL1(j+1) are disposed on the gate insulating layer GI.

The second and third data lines DL2j and DL1(j+1) are covered by an insulating layer INS. In the illustrated exemplary embodiment, the red color pixel R is disposed in the first pixel area PA1 and the green color pixel G is disposed in the second pixel area PA2, for example. However, the invention is not limited thereto, and color pixels having various other colors may be disposed in the first pixel area PA1 and the second pixel area PA2

The first to fourth sub-pixel electrodes SPE1 to SPE4 are disposed on the insulating layer INS. When viewed in a plan view, the first sub-pixel electrode SPE1 of the first pixel Pij is overlapped with the second sub-storage line SSL2 and the third sub-pixel electrode SPE3 of the second pixel Pi(j+1) is overlapped with the third sub-storage line SSL3.

The first and third sub-pixel electrodes SPE1 and SPE3 are spaced apart from each other in the first direction D1 by a predetermined distance. The shielding electrode SCE is disposed between the first pixel Pij and the second pixel Pi(j+1). As shown in FIG. 5, the shielding electrode SCE extends in the second direction D2 along the second and third data lines DL2j and DL1(j+1). The shielding electrode SCE is spaced apart from the first and third sub-pixel electrodes SPE1 and SPE3 to be insulated from the first and third sub-pixel electrodes SPE1 and SPE3.

The shielding electrode SCE is disposed on the insulating layer INS similar to the first and third sub-pixel electrodes SPE1 and SPE3. In an exemplary embodiment, the shielding electrode SCE includes a transparent conductive material, e.g., indium tin oxide (“ITO”) or indium zinc oxide (“IZO”), similar to the first and third sub-pixel electrodes SPE1 and SPE3.

The shielding electrode SCE is applied with the voltage at the same level as that of the common voltage applied to the common electrode CE. Accordingly, the electric field is not generated between the shielding electrode SCE and the common electrode CE. In particular, when the liquid crystal layer LC includes the negative liquid crystal molecules, the liquid crystal molecules are vertically aligned to the surface of the shielding electrode SCE in the non-electric field state.

As described above, when the liquid crystal molecules are vertically aligned, the light provided from the backlight assembly may be blocked by the liquid crystal molecules vertically aligned. Therefore, the area in which the shielding electrode SCE is provided may serve as a first light blocking area to block the light provided from the backlight assembly.

As described above, since the shielding electrode SCE is provided along the second and third data lines DL2j and DL1(j+1), the first light blocking area may be provided in the second direction D2.

The black matrix BM is not provided on the second substrate SUB2 corresponding to the area in which the shielding electrode SCE is provided.

The second substrate SUB2 includes a protrusion pattern PR, an overcoating layer OC, and the common electrode CE.

The protrusion pattern PR is protruded from the upper surface of the second base substrate BS2. The protrusion pattern PR is provided on the second base substrate BS2 and extends along the second direction D2. The protrusion pattern PR is provided along the shielding electrodes SCE and has a width W22 greater than a width W21 of the shielding electrode SCE to cover the shielding electrode SCE when viewed in a plan view. In addition, the width W22 of the protrusion pattern PR covers the first and second data lines DLj and DLj+1 when viewed in a plan view. Further, the width W22 of the protrusion pattern PR is greater than a width W23 of the second and third sub-storage lines SSL2 and SSL3 to cover the second and third sub-storage lines SSL2 and SSL3 when viewed in a plan view.

The common electrode CE receives the common voltage and faces the first to fourth sub-pixel electrodes SPE1 to SPE4 to generate the electric field between the common electrode CE and the first to fourth sub-pixel electrodes SPE1 to SPE4. The common electrode CE may be provided as a single unitary and individual unit.

As described above, the protrusion pattern PR is disposed in the boundary area between the two adjacent pixels to each other, i.e., in the areas in which the data line and/or shielding electrode are provided. The cell gap in the area in which the protrusion pattern PR is provided is smaller than the cell gap in the area in which the protrusion pattern PR is not provided, and thus the liquid crystal molecules in the area, in which the protrusion pattern PR is provided, have the response speed faster than the response speed of the liquid crystal molecules in the areas, in which the protrusion pattern PR is not provided.

Referring to FIGS. 5 and 6B again, the second substrate SUB2 further includes the black matrix BM. The black matrix BM includes a material that blocks the light to block unnecessary light.

In an exemplary embodiment, the black matrix BM may have a stripe shape extending in the first direction D1 along the main storage line MSLi and the first and second gate lines GLi−1 and GLi.

When the curved display apparatus DP is curved in the first direction D1, the misalignment does not occur between the first substrate SUB1 and the second substrate SUB2 in the second direction D2. Therefore, the black matrix BM is disposed on the second substrate SUB2 and extends in the first direction D1 to provide a second light blocking area. That is, the second light blocking area may be provided in the first direction D1.

The black matrix BM is omitted from the area of the second substrate SUB2, which corresponds to the first light blocking area defined by the shielding electrode SCE disposed on the first substrate SUB1.

However, the invention is not limited thereto, and the shielding electrode SCE and the black matrix BM may be disposed in a cross area of the first and second gate lines GLi−1 and GLi, the main storage line MSLi, and the first, second, third, and fourth data lines DL1j, DL2j, DL1(j+1), and DL2(j+1).

In the above-described figures, the curved display apparatus DP is curved in a certain one direction, e.g., the first direction D1. However, when the curved display apparatus DP is curved in the first and second directions D1 and D2 or in a hemi-spherical shape, the shielding electrode SCE may be disposed on the first substrate SUB1 along the first and second directions D1 and D2. In this case, the black matrix BM disposed on the second substrate SUB2 may be omitted.

In the exemplary embodiment, since the protrusion pattern is provided on the second substrate, a misalignment of the liquid crystal molecules caused by a step difference of the protrusion pattern and a light leakage caused by the misalignment may occur.

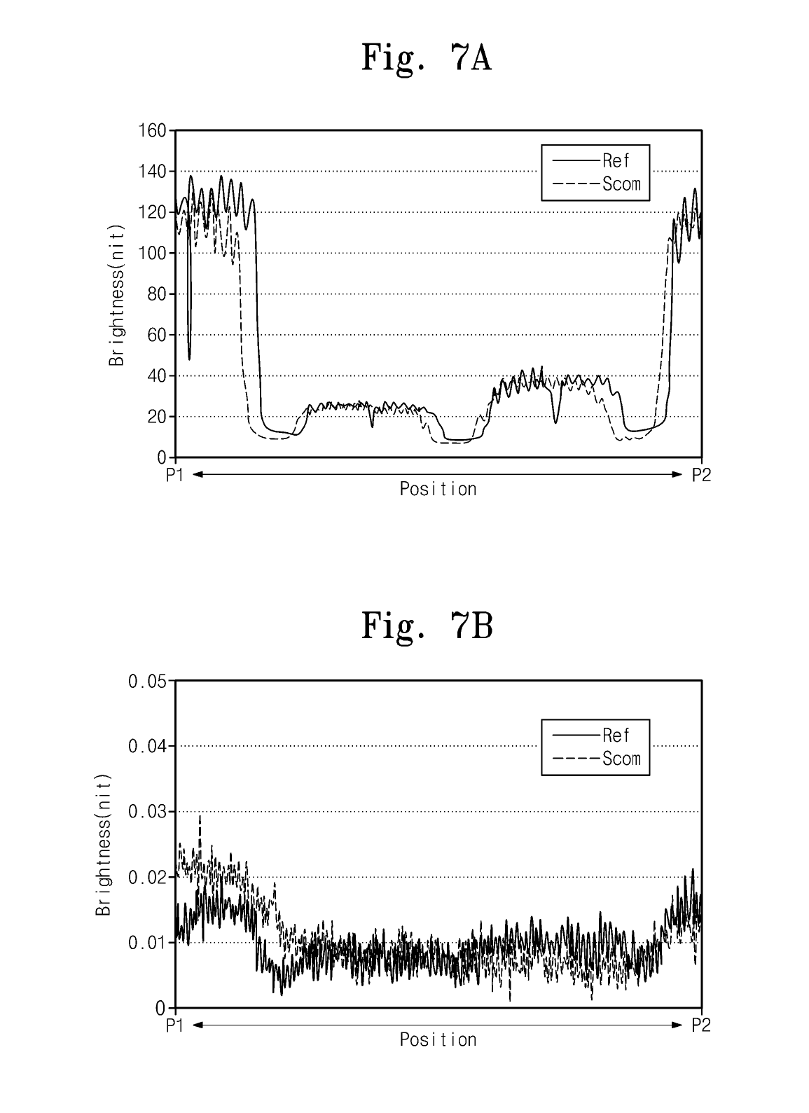

FIG. 7A is a graph showing a brightness measured in terms of nit in the boundary area between the two adjacent pixels of the curved display apparatus when the pixels are driven to display a white color according to an exemplary embodiment of the invention and FIG. 7B is a graph showing a brightness in the boundary area between the two adjacent pixels of the curved display apparatus when the pixels are driven to display a black color according to an exemplary embodiment of the invention. In FIGS. 7A and 7B, a first graph Ref is a position graph of a conventional curved display apparatus not including the protrusion pattern and a second graph Scom is a position graph of the curved display apparatus including the protruding pattern according to the invention. Here, the curved display apparatus has the structure shown in FIG. 5 and the position measured between a first position P1 and a second position P2 shown in FIG. 5.

Referring to FIGS. 7A and 7B, when the light leakage occurs due to the protrusion pattern, abnormal brightness is observed in the first and second graphs. However, the abnormal brightness is not observed in the first and second graphs. This means that the light leakage does not occur in the curved display apparatus according to the invention even though the curved display apparatus includes the protrusion pattern.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A curved display apparatus curved in a first direction, comprising:
a first substrate which comprises:
a first base substrate; and
a plurality of pixel electrodes disposed on the first base substrate;
a second substrate which comprises:
a second base substrate;
a protrusion pattern disposed between two adjacent pixel electrodes among the plurality of pixel electrodes when viewed in a plan view and protruded from the second base substrate; and
a common electrode which is disposed on the second base substrate and configured to generate an electric field in cooperation with the plurality of pixel electrodes, and
a liquid crystal layer interposed between the first substrate and the second substrate.

2. The curved display apparatus of claim 1, wherein
the first substrate further comprises a plurality of signal lines disposed on the first base substrate, and an insulating layer covering the signal lines, and
the protrusion pattern is disposed along the plurality of signal lines extending in a second direction crossing the first direction among the plurality of signal lines, when viewed in the plan view.

3. The curved display apparatus of claim 2, wherein
the first substrate further comprises a shielding electrode disposed along the plurality of signal lines extending in the second direction among the plurality of signal lines and electrically insulated from the plurality of pixel electrodes.

4. The curved display apparatus of claim 3, wherein the protrusion pattern has a width equal to or greater than a width of the shielding electrode when viewed in the plan view.

5. The curved display apparatus of claim 4, wherein
the protrusion pattern protrudes from an upper surface of the second base substrate and has a height of λ*m/(2*Δn),
where “λ” is a wavelength of light, “m” is a positive odd number and “Δn” is the refractive index anisotropy of the liquid crystal layer.

6. The curved display apparatus of claim 3, wherein the protrusion pattern comprises an organic material.

7. The curved display apparatus of claim 3, further comprising an overcoating layer disposed between the protrusion pattern and the common electrode.

8. The curved display apparatus of claim 3, wherein the shielding electrode receives a voltage at the same level as that of a voltage applied to the common electrode.

9. The curved display apparatus of claim 3, wherein the liquid crystal layer comprises negative type liquid crystal molecules.

10. The curved display apparatus of claim 3, wherein
the plurality of signal lines comprises:
gate lines extending in the first direction; and
data lines extending in the second direction, and
the shielding electrode is disposed along the data lines.

11. The curved display apparatus of claim 10, wherein the shielding electrode has a width equal to or greater than a width of the data lines when viewed in the plan view.

12. The curved display apparatus of claim 10, wherein the second substrate further comprises a black matrix disposed on the second base substrate and extending along the gate lines.

13. The curved display apparatus of claim 10, wherein
each of the plurality of pixel electrodes is electrically insulated from an adjacent pixel electrode of the plurality of pixel electrodes, with at least one data lines of the data lines disposed therebetween, and
the shielding electrode is disposed between the two adjacent pixel electrodes.

14. The curved display apparatus of claim 13, wherein the shielding electrode is disposed on the insulating layer and comprises a same material as that of the plurality of pixel electrodes.

15. The curved display apparatus of claim 3, wherein the insulating layer comprises red, green, and blue color pixels.

16. The curved display apparatus of claim 3, wherein
each of the plurality of pixel electrodes comprises a first sub-pixel electrode and a second sub-pixel electrode, which are arranged in the second direction, and
the second substrate further comprises a black matrix extending in the first direction between the first sub-pixel electrode and the second sub-pixel electrode.

17. The curved display apparatus of claim 16, wherein the first sub-pixel electrode comprises at least two domains arranged in the second direction and the at least two domains have different liquid crystal alignment directions.

18. The curved display apparatus of claim 16, wherein the second sub-pixel electrode comprises at least two domains arranged in the second direction and the at least two domains have different liquid crystal alignment directions.

19. The curved display apparatus of claim 16, wherein
the plurality of signal lines comprises:
gate lines extending in the first direction;
a first data line extending in the second direction and electrically connected to the first sub-pixel electrode; and
a second data line extending in the second direction and electrically connected to the second sub-pixel electrode, and
the shielding electrode extends along the first and second data lines.

20. The curved display apparatus of claim 19, wherein the black matrix extends along the gate lines and is configured to cover the gate lines when viewed in a plan view.
